(19) United States
(12) Patent Application Publication
(10) Pub. No.: US 2006/0260107 A1
(43) Pub. Date: Nov. 23, 2006

(54) Manufacturing method of humidity sensor

(75) Inventors: Toshikazu Itakura, Toyota-city (JP); Toshiki Isogai, Nagoya-city (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); NIPPON SOKEN, INC., Nishio-city (JP)

(21) Appl. No.: 11/435,862

(22) Filed: May 18, 2006

(30) Foreign Application Priority Data
May 19, 2005 (JP) 2005-147189
Apr. 3, 2006 (JP) 2006-102397

(51) Int. Cl. H01G 9/00

(52) U.S. Cl. 29/25.03

(57) ABSTRACT

A manufacturing method of a humidity sensor having a moisture-sensitive film formed of a polymer membrane is disclosed. The method involves performing a first heat treatment process in which the polymer membrane is heat treated at a temperature that is at least approximately equal to a glass transition temperature of the polymer membrane. The method also involves performing a second heat treatment process in which the polymer membrane is heat treated at a temperature that is at most approximately equal to the glass transition temperature of the polymer membrane in a predetermined ambient humidity.

### CROSS REFERENCE TO RELATED APPLICATION

This application is based on Japanese Patent Application No. 2005-147189, filed on May 19, 2005, and Japanese Patent Application No. 2006-102397, filed on Apr. 3, 2006, the disclosures of which are incorporated herein by reference.

### FIELD OF THE INVENTION

The present invention relates to a manufacturing method of a humidity sensor and, more particularly, relates to a manufacturing method of a humidity sensor having a moisture-sensitive film formed of a polymer membrane.

### BACKGROUND OF THE INVENTION

Humidity sensors having a moisture-sensitive film formed of a polymer membrane and manufacturing methods for the same are disclosed in, for example, U.S. Pat. No. 6,580,600 (Japanese Patent Application 2002-243690A) and Japanese Patent Application 2003-232765A.

FIG. 4 is a schematic sectional view of the capacitance type humidity sensor 90 disclosed in U.S. Pat. No. 6,580,600. As shown, the humidity sensor 90 includes a humidity sensing portion and a circuit element portion formed on one side of a semiconductor substrate 1.

In the humidity sensing portion, two electrodes 5a, 5b are included on the silicon oxide film 2 formed on the semiconductor substrate 1. The electrodes 5a, 5b are disposed at a distance from each other. A silicon nitride film 3 covers the electrodes 5a, 5b, and a moisture-sensitive film 4 covers the silicon nitride film 3 over the electrodes 5a, 5b. The moisture-sensitive film 4 is formed of a polyimide polymer membrane. The permittivity of the film 4 changes according to changes in the ambient humidity. Accordingly, the capacitance between the electrodes 5a, 5b changes according to changes in the ambient humidity.

The circuit element portion is constructed of a reference capacitance portion and a CMOS transistor etc formation portion. Change in the capacitance between the electrodes 5a, 5b in the humidity sensing portion is compared with the capacitance of the reference capacitance portion. Resulting signals are processed at the CMOS transistor etc formation portion. Thus, changes in the capacitance between the electrodes 5a, 5b caused by changes in humidity are measured. Accordingly, ambient humidity is measured.

Humidity sensors, such as the humidity sensor 90 illustrated in FIG. 4, having a moisture-sensitive film formed of a polymer membrane have a problem. When such a humidity sensor is left in an environment of high temperature and high humidity for a long time (e.g., approximately 2,000 hours), its output value drifts causing sensitivity fluctuation (e.g., sensitivity increase). The sensitivity may increase because the polyimide used for the moisture-sensitive film is swollen and hydrolyzed, and its water absorption (i.e., volume in which water molecules can be absorbed) is increased.

To address this problem, Japanese Patent Application 2003-232765A discloses polymer membranes for use as a moisture-sensitive film. Specifically, a polymer membrane with a functional group added is used for suppressing hydrolysis. Also, a polymer membrane in which a network structure is formed at ends of molecular chains by adding an acetylene structure is used for suppressing swelling.

Using the polymer membrane disclosed in Patent Document 2003-232765 as the moisture-sensitive film may reduce sensitivity fluctuation. However, swelling may still occur. Thus, when the humidity sensor is exposed to a high temperature and high humidity environment, a humidity measurement error of 10% RH or so is still produced at 100% RH between the humidity sensor in the initial state and the humidity sensor after exposure.

Also, when a humidity sensor whose sensitivity was increased as the result of prolonged exposure to a high temperature and high humidity environment is disposed in a high temperature, low humidity environment, its sensitivity is contrarily reduced. The sensitivity may be reduced because the polyimide used for the moisture-sensitive film has shrunken in the high temperature and low humidity environment, and its water absorption is reduced.

### SUMMARY OF THE INVENTION

Accordingly, a manufacturing method of a humidity sensor having a moisture-sensitive film formed of a polymer membrane is disclosed. The method involves performing a first heat treatment process in which the polymer membrane is heat treated at a temperature that is at least approximately equal to a glass transition temperature of the polymer membrane. The method also involves performing a second heat treatment process in which the polymer membrane is heat treated at a temperature that is at most approximately equal to the glass transition temperature of the polymer membrane in a predetermined ambient humidity.

### BRIEF DESCRIPTION OF THE DRAWINGS

FIG. 1 is a graphical illustration of characteristics of humidity sensors manufactured according to the manufacturing method disclosed herein;

FIG. 2 is a graphical illustration of characteristics of humidity sensors manufactured according to the manufacturing method;

FIG. 3 is a graphical illustration of characteristics of humidity sensors manufactured according to the manufacturing method; and

FIG. 4 is a schematic sectional view of a capacitance type humidity sensor that can be manufactured according to the manufacturing method disclosed herein.

### DETAILED DESCRIPTION OF THE PREFERED EMBODIMENTS

A manufacturing method of a humidity sensor is disclosed. In one embodiment, the manufacturing method is used to produce a humidity sensor 90 similar to the humidity sensor 90 illustrated in FIG. 4. The humidity sensor 90 has a moisture-sensitive film formed of a polymer membrane 4. The polymer membrane 4 is disposed on a substrate 1 as shown. In one embodiment, the polymer membrane 4 is made out of polyimide.

The method involves performing a first heat treatment process in which the polymer membrane 4 is heat treated at a temperature equal to or higher than its glass transition temperature. The method further involves performing a second heat treatment process in which the polymer membrane 4 is then heat treated at a temperature equal to or lower than its glass transition temperature in a predetermined ambient humidity. As such, the polymer membrane 4 is cured in the first heat treatment process and is positively aged in a predetermined ambient humidity, which corresponds to an operational environment, during the second heat treatment process.

This manufacturing method causes the sensitivity of the humidity sensors to remain more stable (i.e., to be less likely to fluctuate from an initial state) after the second heat treatment, in correspondence with various operational environments, and the characteristics of humidity sensors can be stabilized.

More specific description will be given. When polymer molecules, such as polyimide, are swollen, their glass transition temperature is likely lowered. For example, when polyimide containing a relatively small amount of crosslink is swollen, its glass transition temperature is lowered to a temperature close to room temperature and transforms into rubbery state.

Thus, the polymer membrane 4 is sufficiently swollen in an atmosphere of high temperature and high humidity in the second heat treatment process. For a humidity sensor intended for use in a relatively high humidity environment, sensitivity fluctuation from its initial state is substantially reduced. Thus, stable characteristics can be maintained for a relatively long operating time.

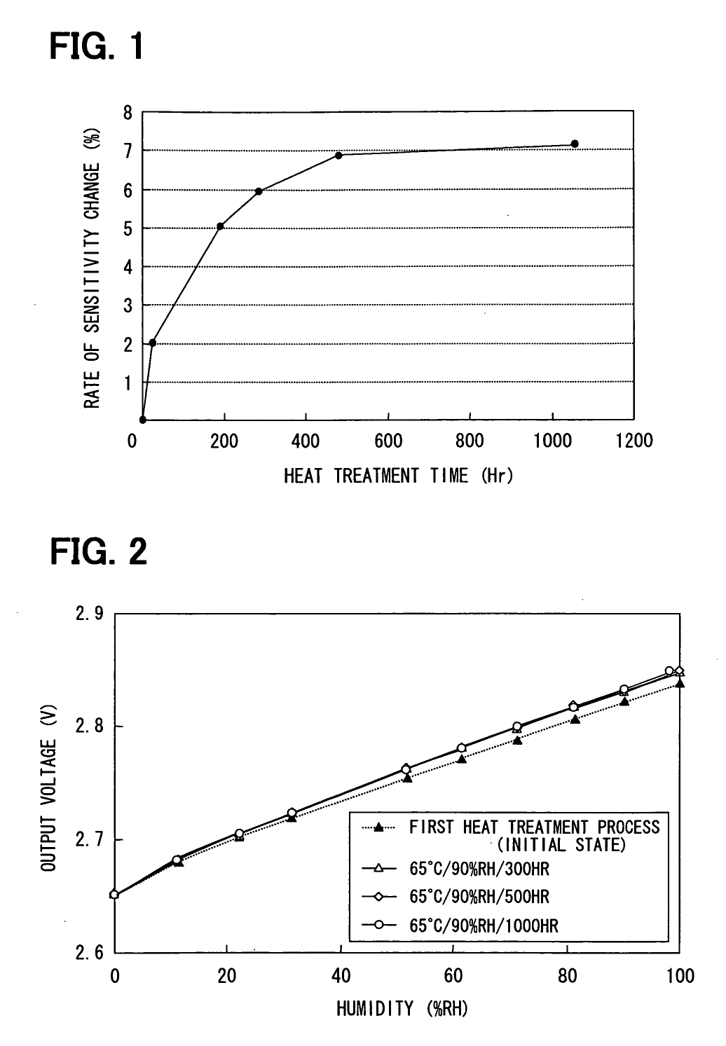

FIG. 1 is a graphical illustration of the characteristics of a humidity sensor 90 manufactured according to the manufacturing method. The humidity sensor 90 includes a polymer membrane formed of polyimide. As shown, the heat treatment time in the second heat treatment process is represented on the horizontal axis, and the rate of sensitivity change of the humidity sensor 90 is represented on the vertical axis. In other words, the vertical axis represents the rate (percentage) of change in the sensitivity of the humidity sensor 90 obtained after the second heat treatment relative to its sensitivity obtained after the first heat treatment.

In the embodiment of FIG. 1, the temperature during the second heat treatment process is approximately 65° C. Also, in the embodiment of FIG. 1, the ambient humidity is approximately 90% RH.

As illustrated in FIG. 1, the output voltage significantly changes when the heat treatment time is shorter than approximately 200 hours. However, the rate of sensitivity change is less apparent when the heat treatment time is 200 hours or longer. Also, the output voltage is saturated and remains significantly constant when the heat treatment time is approximately 500 hours or longer.

FIG. 2 presents additional graphical illustration of the characteristics of the humidity sensor 90 manufactured according to the method disclosed herein. The line including solid triangles represents the characteristics of a humidity sensor 90 once the first heat treatment process, but not the second heat treatment process, has been completed (i.e., the initial state). The line including hollow triangles represents a humidity sensor 90 heat treated during the second heat treatment process at a temperature of 65° C., an ambient humidity of 90% RH, and for a time of 300 hours. The line including hollow diamonds represents a humidity sensor 90 similarly heat treated at 65° C., 90% RH, and for 500 hours. The line including hollow circles represents a humidity sensor 90 similarly heat treated at 65° C., 90% RH, and for 1000 hours.

As is apparent from FIG. 2, the output voltage of the samples that underwent the second heat treatment process at a temperature of 65° C. and a humidity of 90% RH for 300 hours is increased as compared with the sample that underwent the first heat treatment process but did not undergo the second heat treatment (i.e., the initial state). (This output voltage is equivalent to sensitivity represented by the gradient of the graph.) Also, as the humidity approaches 100% RH, increase in output voltage is more pronounced. With respect to the samples that underwent the second heat treatment process for 300, 500, and 1000 hours, their output voltage does not significantly fluctuate versus humidity.

Therefore, in one embodiment, the heat treatment time of the second heat treatment process is at least approximately 200 hours based on the results of FIGS. 1 and 2. More specifically, in one embodiment, the heat treatment time is between approximately 200 hours and 1000 hours. In another embodiment, the time of the second heat treatment is between approximately 500 hours and 1000 hours.

As is apparent from FIG. 1, when the heat treatment time in the second heat treatment process is 200 hours or longer, it is possible to significantly suppress sensitivity fluctuation from the initial state after the second heat treatment. When the heat treatment time in the second heat treatment process is set to 500 hours or longer, the sensitivity fluctuation from the initial state is virtually eliminated. Furthermore, even when the heat treatment time is 1000 hours or longer, the aging effect hardly changes. Therefore, a heat treatment time of 1000 hours or less will reduce manufacturing costs.

As stated, the humidity sensors 90 illustrated in FIG. 1 and FIG. 2 were subjected to a heat treatment temperature (of the second heat treatment process) of 65° C. and an ambient humidity of 90% RH. In another embodiment, the heat treatment temperature in the second heat treatment process is at least approximately 60° C. In another embodiment, the heat treatment temperature is between approximately 60° C. and 150° C. In still another embodiment, the heat treatment temperature is between approximately 65° C. and 90° C.

When the heat treatment temperature in the second heat treatment process is lower than 60° C., the above-mentioned aging effect may not be sufficiently obtained even though the heat treatment time is 1000 hours or longer. Meanwhile, when the heat treatment temperature in the second heat treatment process is set to 60° C. or higher or 65° C. or higher, the above-mentioned aging effect can be sufficiently obtained, and the heat treatment time can be significantly shortened.

When the heat treatment temperature in the second heat treatment process is set to 150° C. or below or 90° C. or below, a commonly used thermo-hygrostat can be utilized to easily carry out the above-mentioned second heat treatment in arbitrary ambient humidity. As a result, the manufacturing cost of the humidity sensor can be suppressed.

If the humidity sensor 90 is intended for use in a relatively high humidity environment, such as Japan, it may be preferable that the ambient humidity in the second heat treatment process be 90% RH or higher. In this embodiment, the polymer membrane 4 is sufficiently swollen in relatively high ambient humidity during the second heat treatment process. Thus, sensitivity fluctuation from the initial state after the second heat treatment is substantially reduced, and stable characteristics can be maintained for a relatively long time.

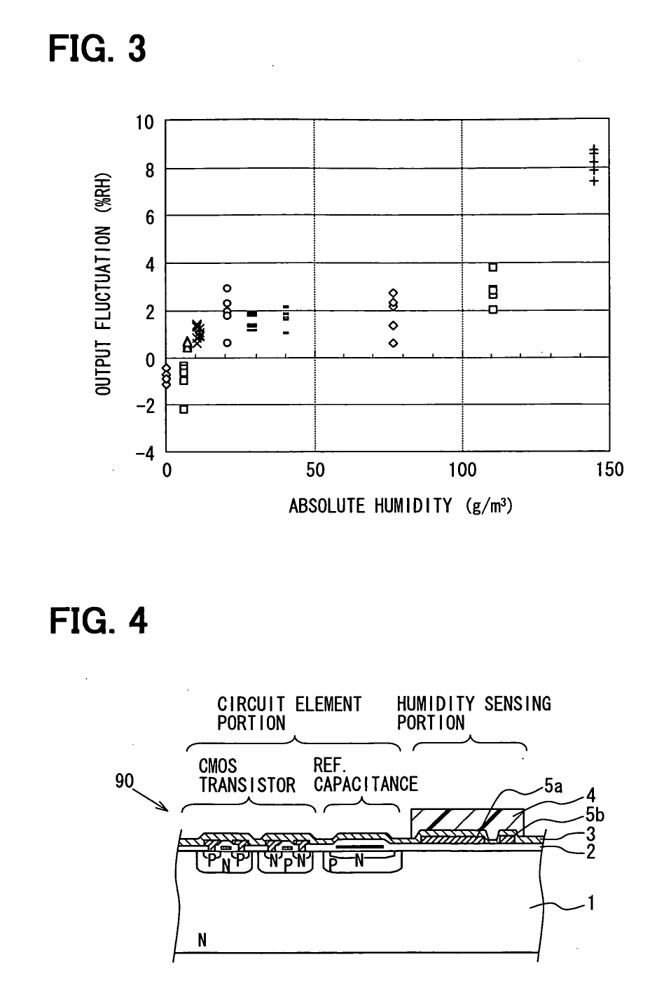

FIG. 3 graphically illustrates the characteristics of humidity sensors 90 that include moisture-sensitive films made of polyimide. Specifically, FIG. 3 illustrates in a lump fluctuation the sensor output obtained after the second heat treatment process was carried out relative to the sensor output obtained before the second heat treatment process was carried out. In the embodiment shown, absolute humidity computed from various conditions was used in the second heat treatment process. The second heat treatment process was carried out under the varied conditions of heat treatment temperature and ambient humidity. The different plot symbols in FIG. 3 correspond to the second heat treatment process under the different conditions of heat treatment temperature and ambient humidity.

With respect to absolute humidity, represented by the horizontal axis, the condition in which the heat treatment temperature is 45° C. and the ambient humidity is 80% RH corresponds to an absolute humidity of approximately 74 g/m³. For example, the condition in which the heat treatment temperature is 37° C. and the ambient humidity is 90% RH, or the condition that gives the maximum possible absolute humidity in the natural condition, corresponds to an absolute humidity of approximately 40 g/m³.

As is apparent from the result illustrated in FIG. 3, where the absolute humidity is approximately 110 g/m³ or below, output fluctuation is approximately 4% RH or below. Where the absolute humidity is approximately 145 g/m³, output fluctuation is approximately 8% RH. Accordingly, the sensor output is caused to greatly fluctuate due to the swelling phenomenon. Thus, as mentioned above, fluctuation in sensor output due to the second heat treatment process is abruptly increased when the threshold of the absolute humidity is 110 g/m³.

Thus, in one embodiment, the second heat treatment process is carried out such that the absolute humidity is approximately 110 g/m³ or below, taking sufficient time. In this embodiment, as mentioned above, fluctuation in the sensor output obtained after the second heat treatment process is carried out relative to the sensor output obtained before the second heat treatment process is carried out can be suppressed. This facilitates designing and manufacturing, and makes it possible to maintain stable characteristics for a long time after the second heat treatment.

In another embodiment, in order to obtain higher accuracy, the second heat treatment process is carried out such that the absolute humidity is at most approximately 70 g/m³. In still another embodiment, the second heat treatment process is carried out such that the absolute humidity is at most approximately 40 g/m³.

When the glass transition temperature of the polyimide has been lowered to approximately room temperature due to swelling and is exposed to an environment of relatively high temperature (e.g. 80° C. or higher) and low humidity for a significant amount of time, the polyimide is gradually shrunken. Therefore, a humidity sensor intended for use in a relatively low humidity environment, the polymer membrane may be sufficiently shrunken in the second heat treatment process in an atmosphere of a high temperature (e.g. 80° C. to 150° C. or so) approximately equal to or lower than its glass transition temperature. Thus, sensitivity fluctuation from its initial state after the second heat treatment is substantially reduced, and stable characteristics can be maintained for a relatively long time.

As mentioned above, the manufacturing method described above is for humidity sensors having a moisture-sensitive film formed of a polymer membrane. The manufacturing method allows sensitivity fluctuation to be reduced in correspondence with environments in which the humidity sensor will be used. Therefore, the manufacturing method described herein is suitable for the manufacture of in-vehicle humidity sensors used in a variety of environments.

The present invention has been described in an illustrative manner. It is to be understood that the terminology, which has been used, is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A manufacturing method of a humidity sensor having a moisture-sensitive film formed of a polymer membrane, comprising:
performing a first heat treatment process in which the polymer membrane is heat treated at a temperature that is at least approximately equal to a glass transition temperature thereof; and
performing a second heat treatment process in which the polymer membrane is heat treated at a temperature that is at most approximately equal to the glass transition temperature thereof in a predetermined ambient humidity.

2. The manufacturing method according to claim 1, wherein the polymer membrane is a polyimide film.

3. The manufacturing method according to claim 1 wherein the heat treatment temperature of the second heat treatment process is between approximately 600C and 1500C.

4. The manufacturing method according to claim 3, wherein the heat treatment temperature of the second heat treatment process is between approximately 60° C. and 90° C.

5. The manufacturing method according to claim 4, wherein the heat treatment temperature of the second heat treatment process is between approximately 65° C. and 90° C.

6. The manufacturing method according to claim 1, wherein a heat treatment time of the second heat treatment process is between approximately 200 hours and 1000 hours.

7. The manufacturing method according to claim 6, wherein the heat treatment time of the second heat treatment process is between approximately 500 hours and 1000 hours.

8. The manufacturing method according to claim 1, wherein the predetermined ambient humidity of the second heat treatment process is at least approximately 90% RH.

9. The manufacturing method according to claim 1, wherein an absolute humidity of the second heat treatment process is at most approximately 110 g/m³.

10. The manufacturing method according to claim 9, wherein the absolute humidity of the second heat treatment process is at most approximately 70 g/m³.

11. The manufacturing method according to claim 10, wherein the absolute humidity of the second heat treatment process is at most approximately 40 g/m³.

12. The manufacturing method according to claim 1, wherein the humidity sensor is an in-vehicle humidity sensor.
